(19) United States
(12) Patent Application Publication
(10) Pub. No.: US 2003/0001065 A1
(43) Pub. Date: Jan. 2, 2003

(54) Foldable book rest

(76) Inventor: Kenneth Ng, Edmonton (CA)

Correspondence Address: Supreme Patent Services, Post Office Box 2339, Saratoga, CA, 95070-0339, US

(21) Appl. No.: 10/163,384

(22) Filed: Jun. 4, 2002

(30) Foreign Application Priority Data
Jun. 29, 2001 (TW) 090211008

(51) Int. Cl. F16M 11/00

(52) U.S. Cl. 248/460; 248/175

(57) ABSTRACT

A book rest includes a primary frame having bottom and top bars connected by opposite side bars for supporting a book thereon and a secondary frame pivoted to the side bars of the primary frame to be movable with respect to the primary frame between a folded position and an expanded position where an included angle is formed between the primary frame and the secondary frame for supporting the book at a corresponding angular position. A Velcro strip has first and second end sections on which hooks and loops are respectively formed. The first end of the Velcro strip is fixed to the bottom bar of the primary frame and the second end of the Velcro is folded over a bar of the secondary frame and overlaps the first end section to releasably fix the included angle between the primary and secondary frame whereby the angular position of the primary frame and thus that of the book supported on the book rest can be adjusted. The secondary frame can be moved into inside the primary frame for completely folding the book rest. Each side bar of the primary frame is provided with a page retention member that is biased by a spring to securely engage pages of a book supported on the book rest thereby effectively retaining the pages in the open condition.

### FIELD OF THE INVENTION

The present invention relates generally to a book rest, and in particular to a book rest having a foldable structure and being adjustable in viewing angle.

### BACKGROUND OF THE INVENTION

Book rests are commonly used in retaining a book in a desired angular position for helping people, especially the disabled, to read the book. To meet the personal requirement of each particular user, the book rest is sometimes made adjustable in the angular position that it supports a book. An example is shown in U.S. Pat. No. 6,293,591. However, such a known adjustable book rest has a complicated structure and sometimes requires sophisticated operations. On the other hand, some of the known book rests have a simple structure and are easy to use. However, such book rests are not capable of adjustment of the angular position that they support a book for being suitable for different users.

FIGS. 1 and 2 show two examples of the conventional book rests that have a simple structure. The book rest shown in FIG. 1 comprises a main frame A and two side frames B extending from opposite sides of the main frame A. Each side frame B forms a recess 11 for receiving a lower portion of a book (not shown) therein and an inclined book support arm 12 extending between the main frame A and the recess 11 for supporting the book in a predetermined angular position. A projection C is formed on the side frame B and substantially parallel to the book support arm 12 for retaining the book that is supported by the book support 12 in an open condition.

The book rest shown in FIG. 2 comprises a main frame A and two side frames B extending from opposite sides of the main frame A for supporting the main frame A in a predetermined angular position. Two L-shaped members (not labeled) extend from the opposite sides of the main frame A and each forms a recess 11 for receiving a lower portion of a book (not shown) and a projection C for retaining the book in an open condition.

Both designs of FIGS. 1 and 2 allow the side frames B to be folded into the main frame A for reducing the overall size thereof in storage. However, these conventional designs do not allow a substantial adjustment of the angular position (such as 30-70 degrees) that a book is supported on the book rest. In addition, although the conventional designs of the book rest provide means for retaining the book in open condition, such means is not effective in retaining the pages of the book in a “completely open” condition for convenient reading by the reader. In other words, pages of the book may, due to resiliency thereof, partially resume closed condition and thus interfering with the eyesight of the reader.

### SUMMARY OF THE INVENTION

Thus, an object of the present invention is to provide a book rest having a simple structure while allowing effective adjustment of angular position that a book is supported thereon.

Another object of the present invention is to provide a book rest having a page retention device for effectively retaining pages of a book that is supported on the book rest in a “completely open” condition for easy reading.

To achieve the above object, in accordance with the present invention, there is provided a book rest comprising a primary frame having bottom and top bars connected by opposite side bars for supporting a book thereon and a secondary frame pivoted to the side bars of the primary frame to be movable with respect to the primary frame between a folded position and an expanded position where an included angle is formed between the primary frame and the secondary frame for supporting the book at a corresponding angular position. A Velcro strip has first and second end sections on which hooks and loops are respectively formed. The first end of the Velcro strip is fixed to the bottom bar of the primary frame and the second end of the Velcro is folded over a bar of the secondary frame and overlaps the first end section to releasably fix the included angle between the primary and secondary frame whereby the angular position of the primary frame and thus that of the book supported on the book rest can be adjusted. The secondary frame can be moved into inside the primary frame for completely folding the book rest. Each side bar of the primary frame is provided with a page retention member that is biased by a spring to securely engage pages of a book supported on the book rest thereby effectively retaining the pages in the open condition.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a conventional book rest;

FIG. 2 is a perspective view of another conventional book rest;

FIG. 3 is an exploded view of a book rest constructed in accordance with the present invention;

FIG. 4A is a perspective view of the book rest of the present invention in an expanded condition;

FIG. 4B is another perspective view of the book rest of the present invention in an expanded condition at an angular position different from the expanded condition shown in FIG. 4A;

FIG. 4C is a perspective view of the book rest of the present invention in a folded condition;

FIG. 4D is a perspective view of a Velcro strip employed in the book rest of the present invention for adjustably fixing the book rest at a corresponding angular position;

FIG. 4E is an enlarged view of encircled portion 4E of FIG. 4D;

FIG. 4F is an enlarged view of encircled portion 4F of FIG. 4D;

FIG. 5A is a front view showing a book supported on the book rest of the presenting invention with pages of the book securely retained in an open condition by a page retention device of the book rest;

FIG. 5B is similar to FIG. 5A but showing the pages of the book securely retained in open condition by the page retention device in another way;

FIG. 5C is a side elevational view showing the page retention device in accordance with the present invention;

FIG. 5D is a side elevational view showing an alternative page retention device in accordance with the present invention;

FIG. 6 is a perspective view of a book rest constructed in accordance with another embodiment of the present invention;

FIG. 7A is an exploded view showing a page retention device in accordance with a further embodiment of the present invention;

FIG. 7B is a perspective view of the page retention device in a secured condition;

FIG. 7C is a perspective view of the page retention device in a released condition; and

FIG. 7D is a perspective view of an alternative of the page retention device in a secured condition.

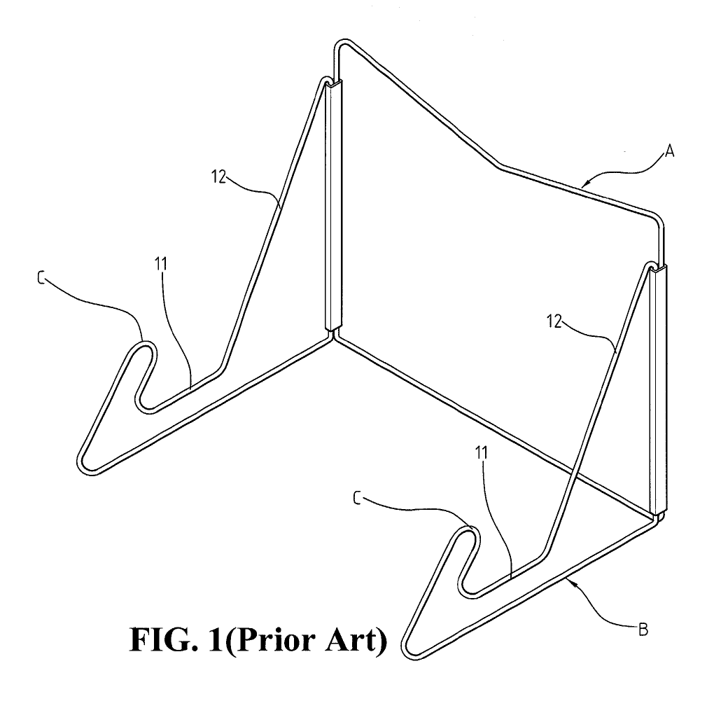

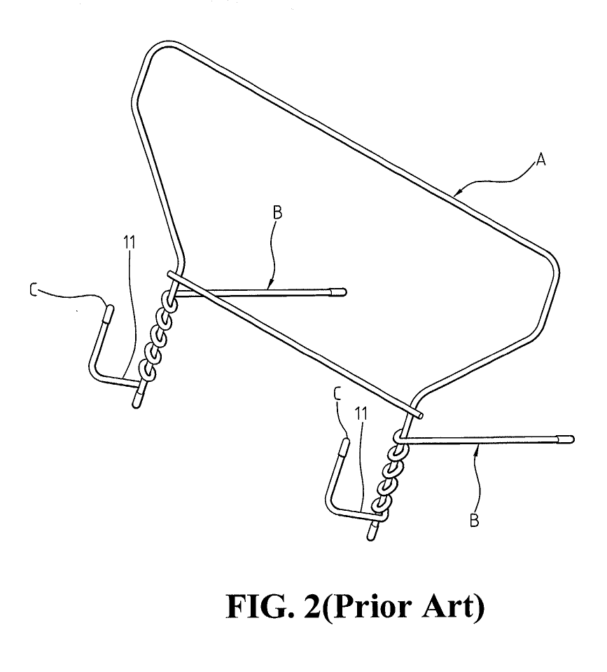

### DETAILED DESCRIPTION OF THE INVENTION

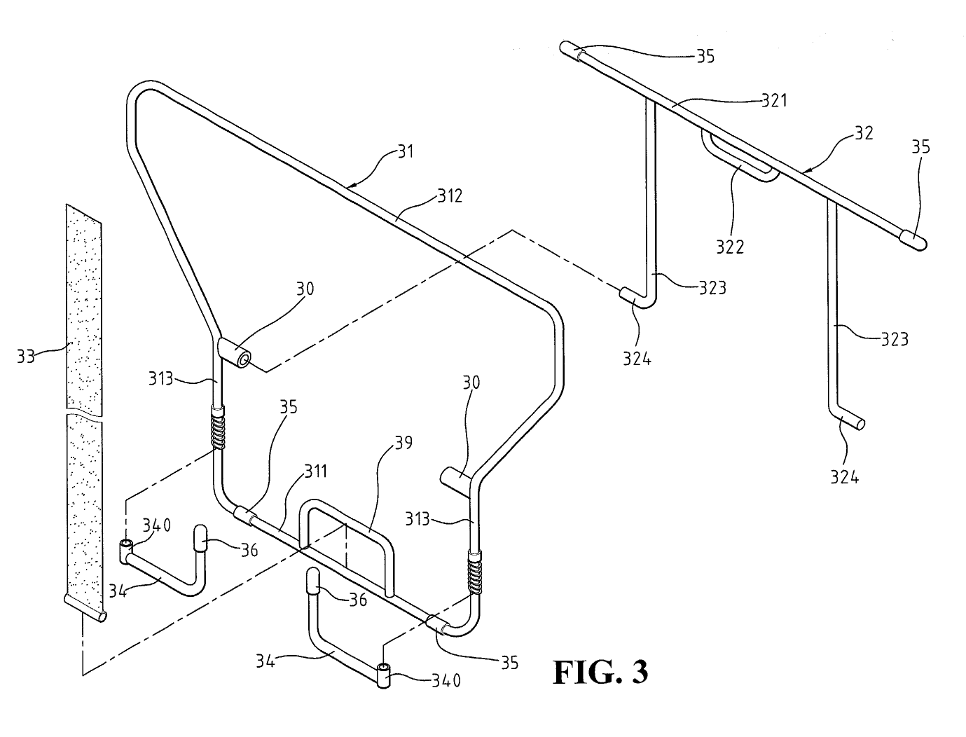

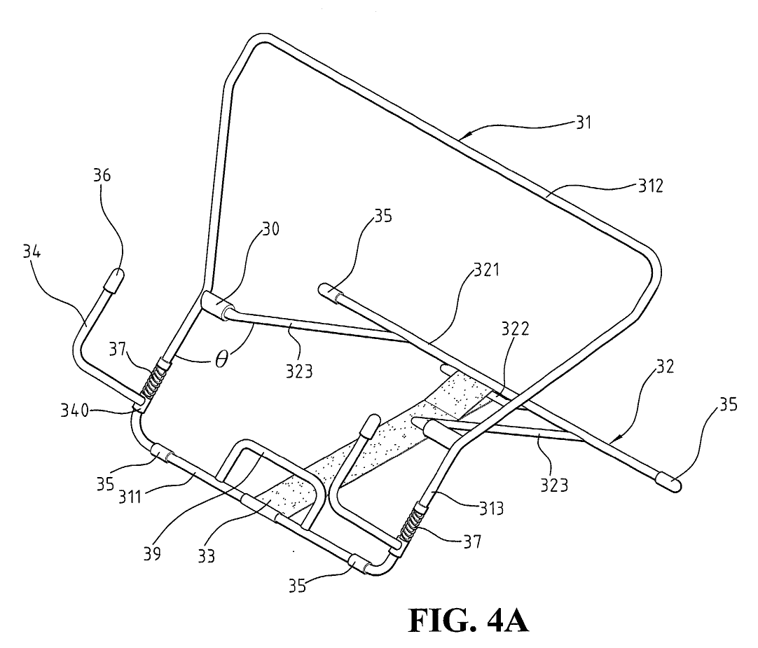

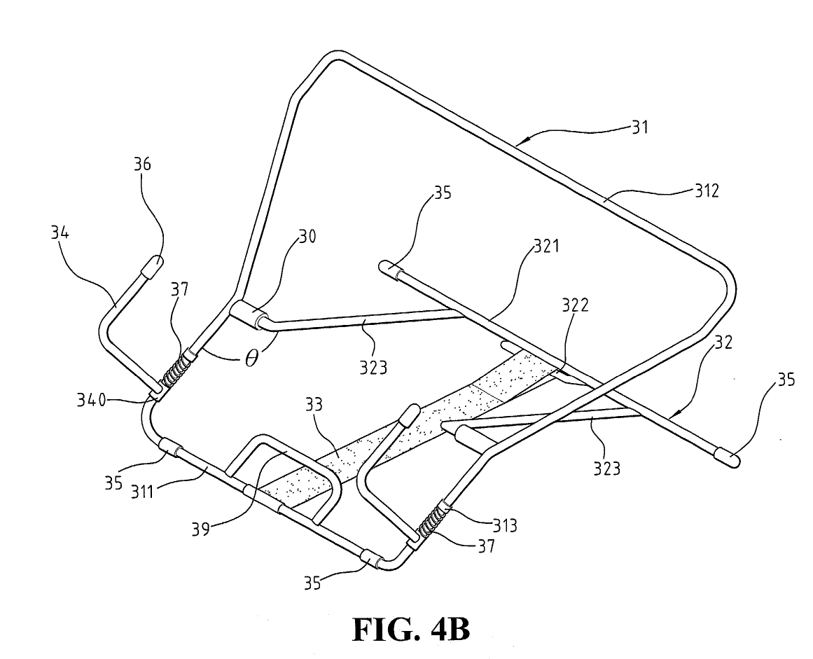

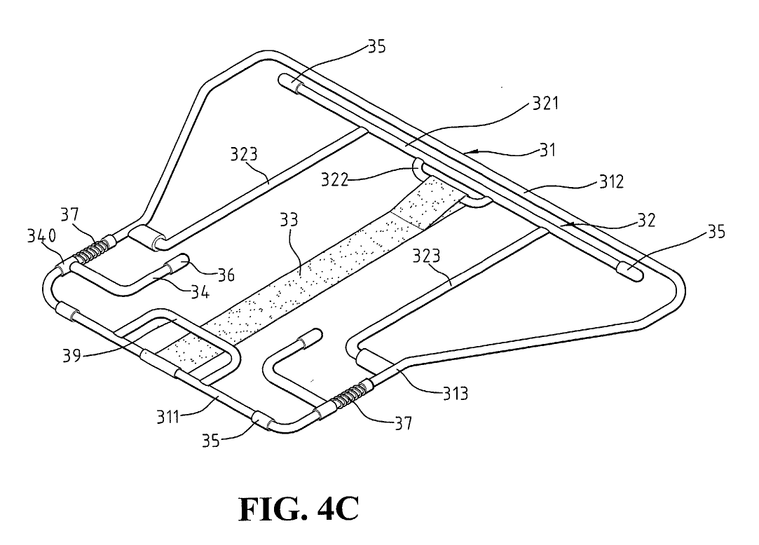

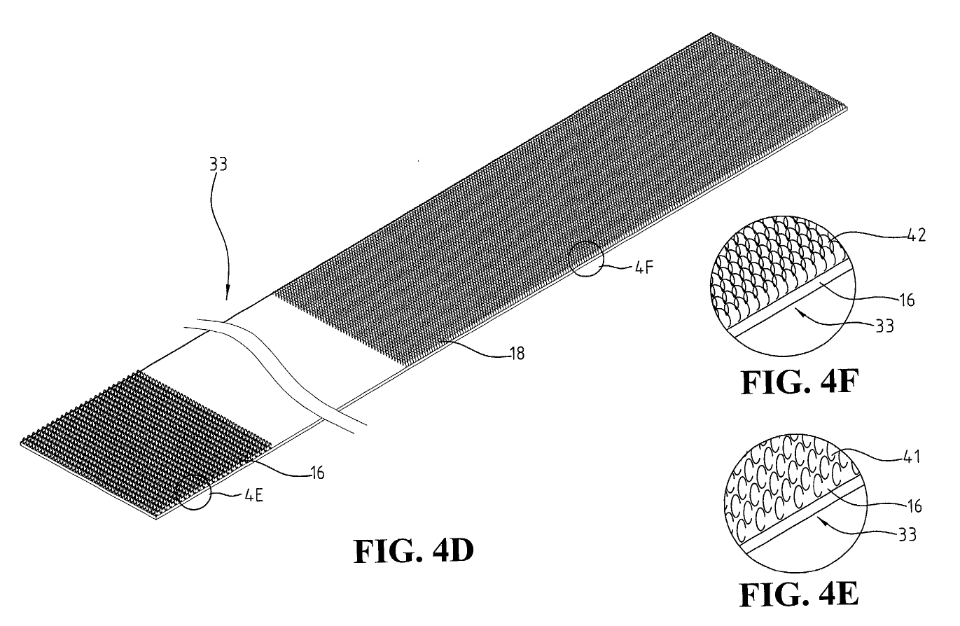

With reference to the drawings and in particular to FIGS. 3 and 4A-4C, a book rest constructed in accordance with the present invention comprising a primary frame 31 having two opposite sides between which a secondary, support frame 32 is rotatably mounted whereby the support frame 32 is movable between a folded condition (FIG. 4C) and an expanded condition (FIGS. 4A and 4B) where the support frame 32 supports the primary frame 31 in any desired angular position with respect to a horizontal surface, such as a desk (not shown), by change an included angle θ between the primary frame 31 and the support frame 32 whereby a book (not shown) is supported by the primary frame 31 at a desired viewing angle for a reader.

In the embodiment illustrated, the primary frame 31 is made of stiff wire in the form of a closed frame having a bottom bar 311 and an opposite top bar 312 connected by two bent and substantially symmetric side bars 313. The support frame 32 comprises an elongate bar 321 and two arms 323 extending from the elongate bar 321. Each arm 323 forms an L-shaped free end 324 that is rotatably received in a pivot hole 30 formed in the corresponding side bar 313 of the primary frame 31 whereby the elongate bar 321 of the support frame 32 and the bottom bar 311 of the primary frame 31 are engageable with on the desk for positioning the book rest on the desk. The pivot hole 30 is defined by a tubular member extending from the side bar 313 of the primary frame 31 in the embodiment illustrated. The rotatable engagement between the L-shaped free end 324 of each arm 323 of the support frame 32 and the tubular member 30 of the corresponding side bar 313 of the primary frame 31 allows the primary frame 31 and the support frame 32 to rotate with respect to each other for changing the included angle θ therebetween.

Also referring to FIGS. 4D-4F, an adjusting device 33 is coupled between the primary frame 31 and support frame 32 for releasably retaining the support frame 32 at a particular included angle with respect to the primary frame 31 thereby selectively fixing the angular position of the book supported by the primary frame 31. The adjusting device 33 comprises an elongate member or a strip connected between the bottom bar 311 of the primary frame 31 and a loop 322 formed on the elongate bar 321 of the support frame 32. By changing the length of the elongate member 33 between the primary frame 31 and the support frame 32, the included angle θ between the primary frame 31 and the support frame 32 is adjustable. In the embodiment illustrated, the elongate member 33 comprises a Velcro® strip having first and second end sections 16, 18 on which hook-type engaging elements 41 (FIG. 4E) and loop-type engaging elements 42 (FIG. 4F) are respectively formed. The second end of the strip 33 is securely attached to the bottom bar 311 of the primary frame 31, while the first end section 16 of the strip 33 extends through the loop 322 of the support frame 32 and folded over and partially overlap the second end section 18 to have the loop-type and hook-type engaging elements 42, 41 engaging each other, thereby fixing the length of the strip 33 and thus the included angle θ between the primary frame 31 and the support frame 32. By folding different lengths of the strip 33 over the loop 322 of the elongate bar 321 of the support frame 32, the included angle θ between the primary frame 31 and the support frame 32 is adjusted, as shown in FIGS. 4A and 4B.

The primary frame 31 is sized to substantially accommodate the support frame 32 therein when the included angle θ therebetween is made 180 degrees as shown in FIG. 4C. This reduces the overall size of the book rest when it is not in use. Preferably, the Velcro strip 33 has an overall length sufficient to accommodate folding operation of the book rest.

A book support device 39 is formed on the bottom bar 311 of the primary frame 31 to effectively support the backbone of the book positioned on the book rest. In the embodiment illustrated, the book support device 39 comprises an inverted U-shaped bar mounted to the bottom bar 311 of the primary frame 31 with a top edge of the inverted U-shaped bar being substantially higher than the bottom bar 311 of the primary frame 31 thereby capable to provide effective support to the backbone of the book.

Collars or rings 35 made of a soft or high friction material are mounted to or fit over the bottom bar 311 of the primary frame 31 and the elongate bar 321 of the support frame 32 for protection of the desk on which the book rest is placed. Preferably, the collars 35 are made of a material that has a remark friction with the desk so as to retain the book rest on the desk.

If desired, the collars 35 of the elongate bar 321 of the support frame 32 can be used to retain the support frame 32 in the folded condition by frictionally engaging a portion of the primary frame 31.

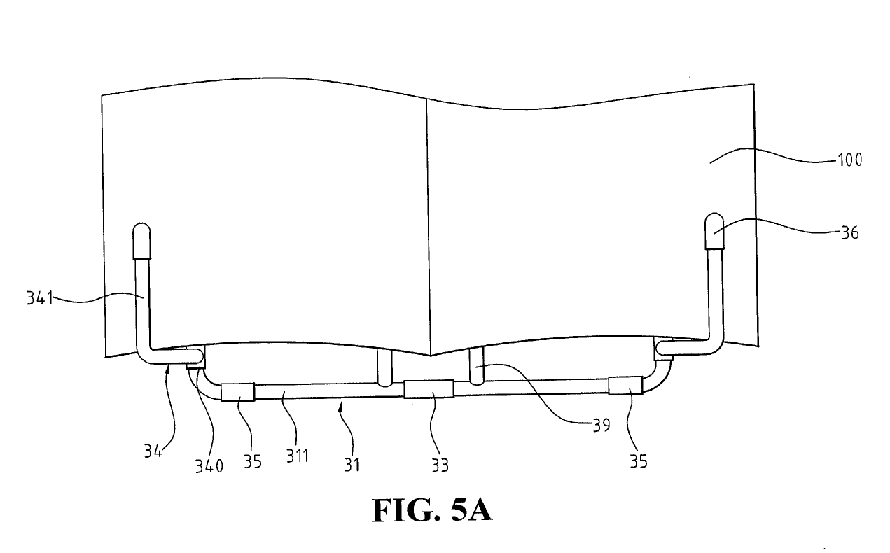

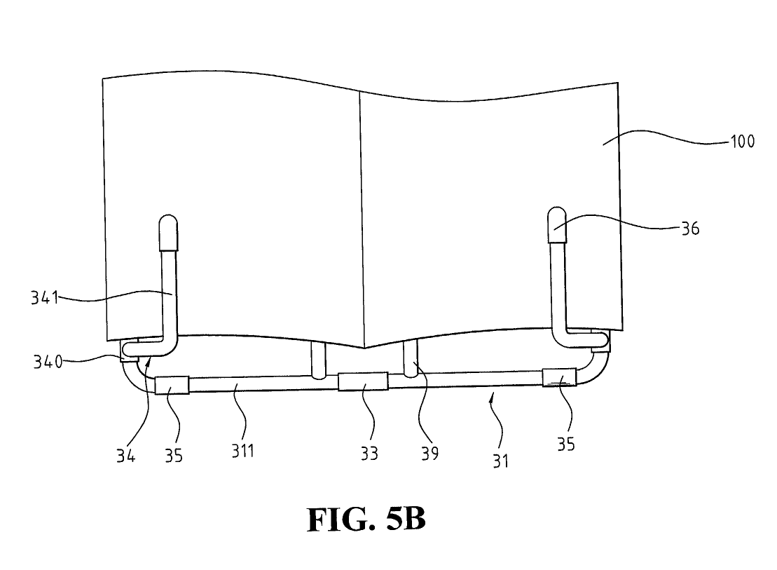

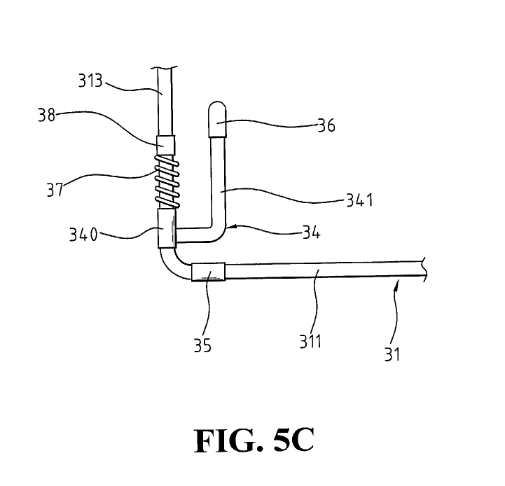

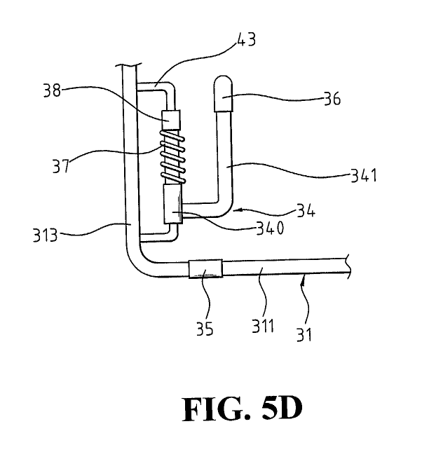

Also referring to FIG. 5C, a page retention device is mounted to each side bar 313 of the primary frame 31. The page retention device 34 comprises a tubular end 340 fit over the side bar 313 of the primary frame 31. A biasing member 37, such as a torsion spring, is mounted between the page retention device 34 and the primary frame 31 for biasing the page retention device 34 to securely engage pages of a book 100 positioned on the book rest as shown in FIGS. 5A and 5B. A retention member 38 that is mounted to the side bar 313 of the primary frame 31 fixes the biasing member 37 on the primary frame 31. In the embodiment illustrated, the page retention device 34 comprises an L-shaped member 341 having a free section (not labeled) substantially parallel to the side bar 313 of the primary frame 31. The L-shaped member 341 defines a space with the side bar 313 of the primary frame 31 for accommodating a lower portion of a book 100 (FIGS. 5A and 5B). The biasing member 37 rotates the L-shaped member 341 about the side bar 313 of the primary frame 31 to have the L-shaped member 341 forcibly engaging the pages of the book 100. The L-shaped member 341 can be biased in clockwise direction or counterclockwise direction as respectively shown in FIG. 5A or 5B.

A friction cap 36 is mounted to a free end (not labeled) of the L-shaped member 341 of the page retention device 34 for effectively engaging and retaining the page of the book 100 in the open condition.

FIG. 5D shows an alternative for mounting the page retention device 34 to the primary frame 31 wherein a U-shaped mount 43 is attached to the side bar 313 of the primary frame 31. The tubular end 340 of page retention device 34 is rotatably fit over the mount 43 and biased by a biasing member 37 fixed to the mount 43 by a retention member 38.

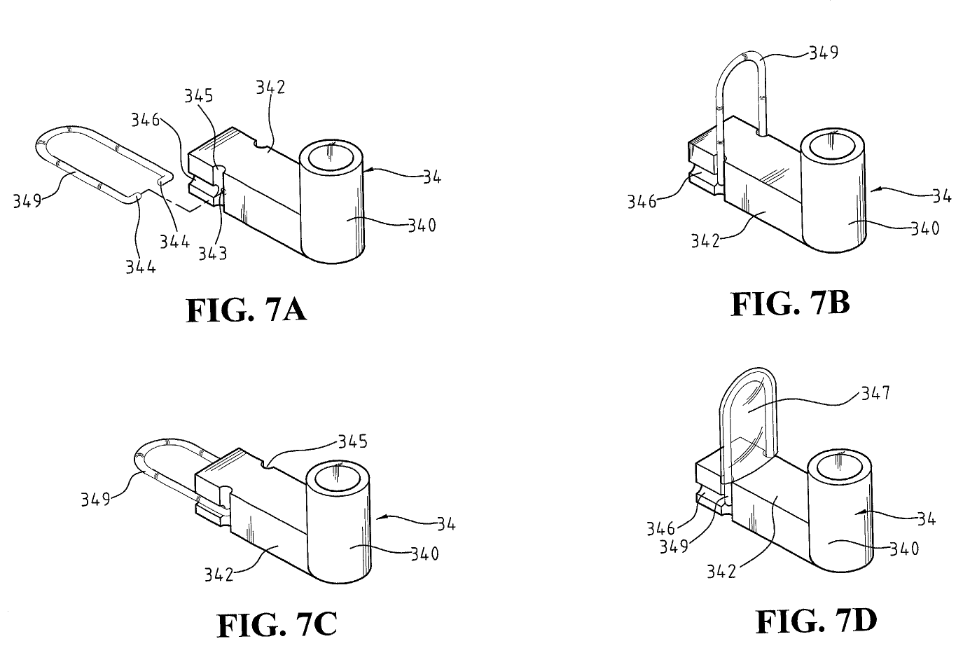

FIG. 7A shows another embodiment of the page retention device 34 wherein the page retention device 34 comprises a book support block 342 extending from a tubular end member 340 of the page retention device 34. The tubular end member 340 is rotatably fit over the corresponding side bar 313 of the primary frame 31. First grooves 345 are defined in opposite side surfaces (not labeled) of the block 342 in a direction substantially parallel to the tubular end member 340. Second grooves 346 are also defined in the side surfaces of the block 342 in a direction substantially normal to the first grooves 345 and intersecting the first grooves 345. A hole 343 is defined in each side surface of the block 342 at the intersection of the first and second grooves 345, 346. A movable member 349 made of a stiff wire in the form of a U-shape having two legs (not labeled) having free ends from which opposite limbs 344 extend. The limbs 344 are rotatably received in the holes 343. The moveable member 349 is resilient so that the legs of the U-shape are biased into the first grooves 345, as shown in FIG. 7B, to maintain engagement of the movable member 349 with pages of a book positioned on the book rest. The movable member 349 can be forced out of the first grooves 345 and sliding into the second groove 346, as shown in FIG. 7C, for disengaging from the pages of the book so as to allow turning page of the book.

FIG. 7D shows an alternative of the embodiment shown in FIG. 7A wherein an enclosure 347 is fit over the movable member 341. The enclosure covered movable member 349 can function as an extension of the block 342 for supporting thick books. In addition, the enclosure 347 can be made of plastics that have a substantial friction with pages of a book for more securely retaining the pages of the book.

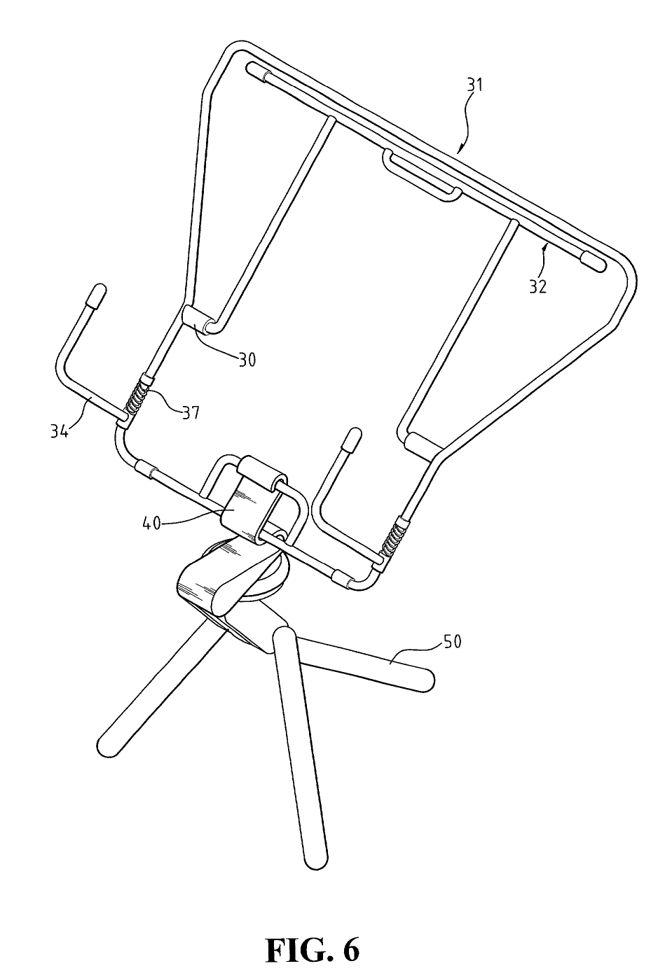

FIG. 6 shows a book rest constructed in accordance with another embodiment of the present invention wherein a mounting device 40 is attached to the book rest of the present invention for mounting the book rest to a tripod 50 or other supports or stands whereby the book rest of the present invention may function as a music stand or the likes.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A book rest adapted to support a book thereon, comprising:
a primary frame having opposite side portions connected by a bottom portion for supporting the book thereon;
a secondary frame pivoted to the primary frame and movable with respect to the primary frame between a folded position and an expanded position where an included angle is formed between the primary frame and the secondary frame for supporting the book at a corresponding angular position; and
an adjusting strip connected to the primary and secondary frames and having an adjustable dimension connected between the primary frame and the secondary frame for selectively changing the included angle between the primary and secondary frames.

2. The book rest as claimed in claim 1 further comprising a retention device mounted to the primary frame for selectively retaining the book in an open condition.

3. The book rest as claimed in claim 2, wherein the retention device comprises an L-shaped member mounted to each of the side portions of the primary frame for accommodating a lower portion of the book therein and a biasing element for biasing the L-shaped member against page of the book.

4. The book rest as claimed in claim 2, wherein the retention device comprises a mount to which a movable member is rotatably attached, the movable member being biased against page of the book.

5. The book rest as claimed in claim 4, wherein the retention member is L-shaped for receiving a lower portion of the book therein, the retention member being slidable along the bar for accommodating books of different sizes.

6. The book rest as claimed in claim 3, wherein the retention device comprises a cap made of a high friction material with respect to the page of the book, the cap being fit over a free end of the L-shaped member for being biased against the page to retain the page in position.

7. The book rest as claimed in claim 2, wherein the book retention device comprises a block formed on each side portion of the primary frame, a first groove and a second groove defined in a side surface of the block and intersecting each other, a hole being defined in the side surface at the intersection of the grooves, a movable member comprising a bar having an end rotatably received in the hole whereby the bar is selectively engageable with the first and second grooves, the first and second grooves being positioned that when the bar engages the first groove, the movable member engages the page of the book for retaining the page in position and when the bar is moved to the second groove, the movable member disengages from the page of the book to allow changing pages of the book.

8. The book rest as claimed in claim 7, wherein first and second grooves are defined in each of opposite side surfaces of the block, a hole being defined in each side surface at the intersection of the first and second grooves, the movable member comprising a U-shaped member having resilient legs from which limbs extend, the limbs being rotatably received in the holes for selectively biasing the legs into the first and second grooves.

9. The book rest as claimed in claim 8 further comprising an enclosure fit over the U-shaped member.

10. The book rest as claimed in claim 3, wherein the biasing element comprises a spring.

11. The book rest as claimed in claim 1, wherein the adjusting strip comprises an elongate member having first and second end sections on which first and second fastening means are mounted, the first end being fixed to the bottom portion of the primary frame, the second end section being extending through and folded over a loop formed in the secondary frame to at least partially overlap the first end section whereby the first and second fastening means releasably engages each other to fix the dimension of the strip between the primary and secondary frames.

12. The book rest as claimed in claim 11, wherein the first and second fastening means comprise loop-type engaging members and the hook-type engaging members.

13. The book rest as claimed in claim 1, wherein the secondary frame comprises an elongate bar and two arms extending from the elongate bar, the arms being pivoted to the side portions of the primary frame whereby the elongate bar of the secondary frame and the bottom portion of the primary frame being positionable on a surface for supporting the book thereon.

14. The book rest as claimed in claim 13, wherein friction elements are mounted to the elongate bar of the secondary frame and the bottom portion of the primary frame.

15. The book rest as claimed in claim 13, wherein each arm has an L-shaped free end rotatably fit into a tubular member mounted to each side portion of the primary frame for pivoting the secondary frame to the primary frame.

16. The book rest as claimed in claim 1, wherein the primary frame is sized to accommodate the secondary frame therein when the secondary frame is at the folded position.

17. The book rest as claimed in claim 16, wherein the secondary frame comprises friction elements frictionally engaging the primary frame to maintain the secondary frame inside the primary frame when the secondary frame is at the folded position.

18. The book rest as claimed in claim 1, wherein a book support member is formed on the bottom portion of the primary frame for supporting backbone of the book.

19. The book rest as claimed in claim 1 further comprising a stand to which the primary frame is mounted.

20. The book rest as claimed in claim 19, wherein the stand comprises a tripod.
